(19) United States
(12) Patent Application Publication
(10) Pub. No.: US 2002/0116359 A1
(43) Pub. Date: Aug. 22, 2002

(54) Method for searching and cataloging on a computer system

(76) Inventor: Joseph S. Tung, Cupertino, CA (US)

Correspondence Address: Fabio E. Marino, SKJERVEN MORRILL MacPHERSON LLP, 25 Metro Drive, Suite 700, San Jose, CA, 95110-1349, US

(21) Appl. No.: 09/791,995

(22) Filed: Feb. 21, 2001

(51) Int. Cl. G06F 7/00

(52) U.S. Cl. 707/1

(57) ABSTRACT

A computer system and method for cataloging objects, such as requests to purchase an item having a certain configuration, associated with a plurality of attributes describing that object. These attributes are stored in an aggregation component, which is linked to a set of permutation arrays. Each of the permutation arrays indicates an allowable ordering of the plurality of attributes. This object can then be matched with a second object, such as an offer to fill the purchase request, by comparing a plurality of attributes associated with the second object to the attributes describing the first object. Improved searching is effectuated by enabling the matching of objects to be based on the acceptable orderings dictated by the permutation arrays.

### BACKGROUND OF THE INVENTION

1. Field of the Invention

The invention relates generally to searching and cataloging objects and, in particular, to searching and cataloging objects using a computer system.

2. Related Art

Various algorithms have been used to sort and search data stored on a computer. One common method for sorting and searching employs Boolean logic keyword searches. A Boolean search is based on certain words or word relationships contained in a relevant collection of materials, and is most appropriate for locating concepts discussed in text-based references. An example of a Boolean search is represented by the following equation:

A∪B∪C

In this example, a search for “A” alone may result in 100 “hits,” or matching documents, a search for “B” alone may result in 80 “hits,” and a search for “C” alone may result in 75 “hits.” The Boolean search links all three keywords, and produces as “hits” only those documents containing A, B, and C. Formulating an accurate and efficient Boolean search requires a certain level of knowledge about the structure of the data, the type of material being searched, the classification of the data, and any keywords or standard terminology likely to be used to express the concepts being searched. The Boolean logic keyword search is less effective when used to locate a particular mix of feature alternatives within a database of product information. A user searching for certain information may not be familiar with the terminology used in selecting a particular product and multiple products may use different, yet synonymous terms.

Furthermore, Boolean logic keyword searching does not take into account the ordering of the keywords in determining matches.

Another popular method of searching is a hierarchical search, sometimes referred to as “tree search” or “tree traversal.” A hierarchical search offers a list of alternatives from which to select. The first list of alternatives has the highest priority and defines the profile of the remaining alternatives. Once selected, the system branches to another (lower level) screen with another list of alternatives. The system branches down through the various menus of alternatives having decreasing priority levels. A hierarchical search is most appropriate for narrowing down to a subset of objects from which to select based on alternatives having a fixed or necessarily depending on the priority level. Hierarchical searches, however, are cumbersome except in cases where the selection of one alternative obviates the availability of other alternatives.

U.S. Pat. No. 5,715,444 to Danish et al. describes a process for identifying a single object from a family of objects by presenting a user with a feature screen having a series of groupings, wherein each grouping represents a feature having a set of alternatives from which to select. Just as the prior art described above, however, Danish fails to take into account an ordering arrangement of features in performing its search. As a result, there is a need for an improved method of cataloging objects using a computer system.

### BRIEF SUMMARY OF THE INVENTION

The present invention provides a computer system and method for cataloging objects that overcome the limitations of the prior art described above. This is accomplished by associating an object with a plurality of attributes using an aggregation component, and then linking the aggregation component with a set of permutation arrays, each indicating an ordering of the plurality of attributes.

As a result, the system and method of the present invention take into account both multiple attributes associated with an object and the ordering of such attributes.

### BRIEF DESCRIPTION OF THE DRAWINGS

FIG. 1 shows the layout of a computer network.

FIG. 2 shows a block diagram of attributes and instances associated with an object.

FIG. 3 illustrates the use of aggregation components and permutation arrays, in accordance with some embodiments of the invention.

FIG. 4 illustrates the use of aggregation components and permutation arrays, in accordance with some embodiments of the invention.

Use of the same reference symbols in different figures indicates similar or identical objects.

### DETAILED DESCRIPTION OF THE INVENTION

In accordance with an embodiment of the present invention, a method is provided for cataloging objects on a computer system. In some embodiments, these objects are queries and responses, as described in co-pending application Ser. No. 09/494,792, titled “Empathic Validation—A Method for Securing Digital Assets,” filed on Jan. 31, 2000, which is incorporated herein by reference in its entirety. In such embodiments, a solution broker provides a Web site to connect or match a solution shopper to a solution provider. The solution provider is a person or entity that possesses digital assets. These digital assets are desired by one or more solution shoppers. The object which is cataloged is either the request for a solution by the solution shopper, or it is the digital asset posted by the solution provider. After a first object is cataloged in the system, the method of cataloging can then be used to match the first object with a second object. In another embodiment, objects are any type of file or document which is stored in a computer connected to a computer network.

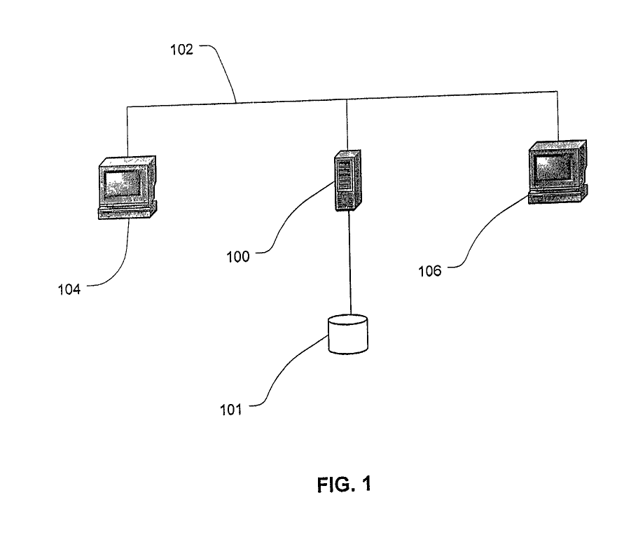

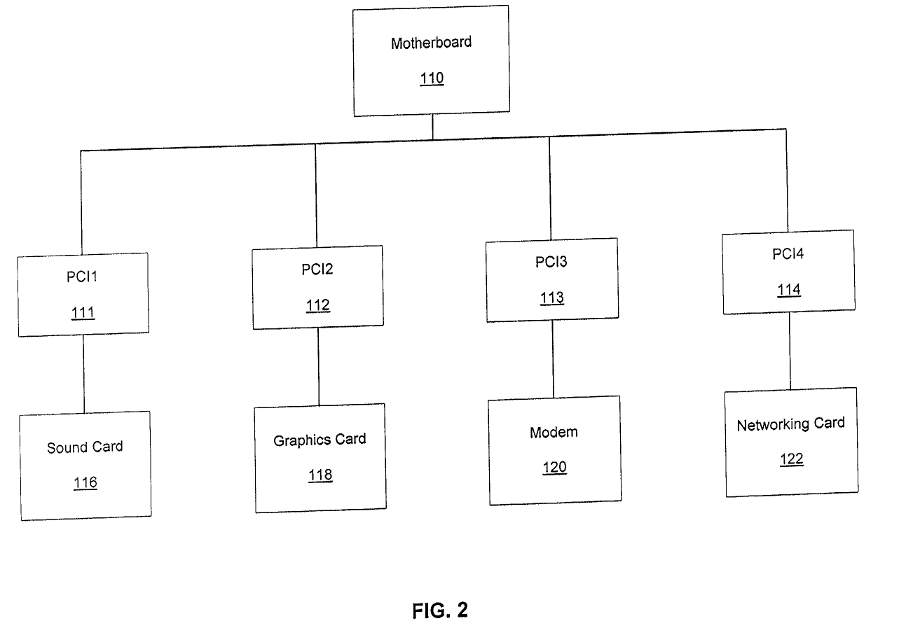

FIG. 1 shows a server 100 connected via a network 102 to a first terminal 104 and a second terminal 106. Network 102 may be a local area network (LAN), wide area network (WAN), or a global-area network, such as the Internet. Server 100 provides access to a database 101. In accordance with some embodiments of the present invention, a first user at first terminal 104 connects with server 100 via network 102 in order to submit a request for a computer system having a desired configuration. The requested computer system includes various components specified by the requestor, such as the monitor, the keyboard, the mouse, and the motherboard. Multiple attributes may be associated with each of these components. FIG. 2 is an illustration showing the specified features for the motherboard 110 of the requested computer system.

The requested specification for the object to be cataloged, motherboard 110, includes multiple attributes, such as, for example, four PCI slots, PCI1 111, PCI2 112, PCI3 113, and PCI4 114. Each of these attributes is associated with an instance, which further defines that attribute. PCI1 111 may be associated with any number of instances, but for the requested system illustrated in FIG. 2, PCI1 111 is associated with a sound card 116, indicating that the requestor would like the requested computer system to include a sound card in its PCI1 slot. Similarly, PCI2 112 is associated with a graphics card 118, PCI3 113 is associated with a modem 120, and PCI4 114 is associated with a networking card 122.

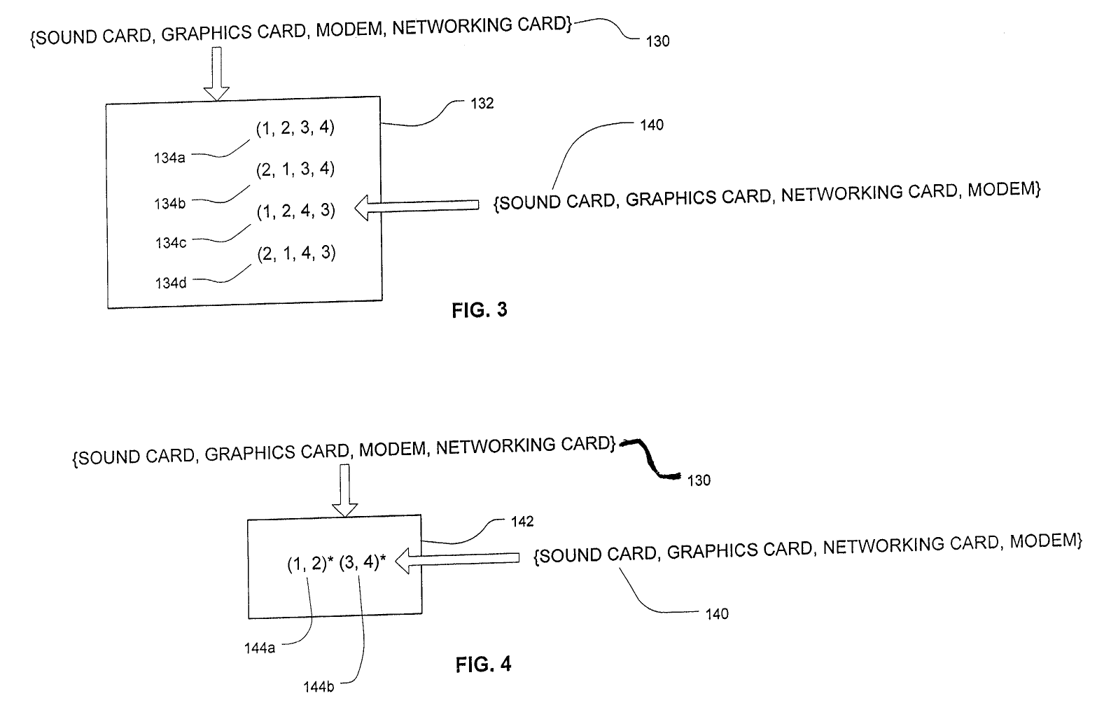

When the requestor specifies the plurality of attributes to be associated with motherboard 110, these attributes are stored in an aggregation component 130, as illustrated by FIG. 3. Aggregation component 130 may contain a list of the attributes alone, or, as shown in FIG. 3, may contain the instances which further define the attributes. Although aggregation component 130 can provide an ordering for the various attributes and their respective instances, the requestor may not require that the components in the requested computer system be installed in the slots exactly as shown in FIG. 2. For example, the requestor may desire a computer system having a sound card 116 installed in either slot PCI1 111 or slot PCI2 112, with the graphics card 118 installed in the unused PCI1 111 or PCI2 112 slot. The request further may allow for variation in the location of modem 120 and networking card 122. These cards may be located in either slot PCI3 113 or PCI4 114. However, it may be important to the requestor that modem 120 and networking card 112 not be located in either PCI1 111 or PCI2 112, and that sound card 116 and graphics card 118 not be located in either PCI3 113 or PCI4 114. Thus, the motherboard 110 object should be cataloged such that the various acceptable ordering arrangements of the attributes can be considered when a second user attempts to match the requested object with a solution.

In accordance with this embodiment, this cataloging is provided by linking aggregation component 130 with a set 132 of permutation arrays 134a-134d. Each permutation array 134a-134d indicates an acceptable ordering for the attributes listed in aggregation component 130. In FIG. 3, sound card 116 corresponds to the number “1,” graphics card 118 corresponds to the number “2,” modem 120 corresponds to the number “3,” and networking card 122 corresponds to the number “4.” Thus, permutation array 134a, which contains the ordering (1, 2, 3, 4), indicates that an acceptable ordering for the attributes in the cataloged object is the ordering as provided in the aggregation component 130.

Permutation array 134b contains the ordering (2, 1, 3, 4), which indicates that a second acceptable ordering of the attributes is one in which the first and second attributes listed in aggregation component 130 are interchanged. Similarly, permutation array 134c contains the ordering (1, 2, 4, 3), which indicates that an ordering in which the third and fourth attributes are interchanged is also allowable. Finally, permutation array 134d contains the ordering (2, 1, 4, 3), which indicates that an ordering in which both the first and second attributes are interchanged and the third and fourth attributes are interchanged is allowable.

By linking aggregation component 130 with the set 132 of permutation arrays 134a-134d, the object (motherboard 110) is cataloged such that more information regarding acceptable permutations of attributes can be considered when searching for the object at a later time. This method of cataloging provides an advantage over conventional cataloging methods in which the various attributes of an object are stored without concern for order or without possibility of variation.

The first object cataloged by first user 104 can then be matched by server 100 with a second object. This second object may be, for example, a query posted by second user 106 onto server 100 to determine whether there have been any requests for computer systems with a certain configuration. Alternatively, the second object may be a motherboard configuration previously stored in database 101. The second user posting the second object may reside at the location of server 100, or may be at a remote location connected to server 100 by a LAN, WAN, or global area network.

The second object is associated with the plurality of attributes listed in a second aggregation component 140. The attributes in aggregation component 140 are then compared to the attributes in aggregation component 130. To do this, the attributes listed in aggregation component 140 are compared to the each of the permutation arrays 134a-134d contained within set 132. As illustrated in FIG. 3, the ordering of attributes in aggregation component 140 does not match either permutation array 134a or 134b. However, the ordering provided by permutation array 134c perfectly matches the ordering of attributes in aggregation component 140, thereby indicating a match between the first object (motherboard 110) and the second object (e.g., a query or a previously cataloged motherboard).

The above-described method advantageously provides for a more accurate matching of objects on a computer. Unlike conventional search tools, which simply consider the existence of attributes, the permutation arrays allow the matching to be based on an ordering of attributes as well.

In an alternative embodiment, permutation array 134a containing the ordering (1, 2, 3, 4) is considered the default ordering of the attributes listed in aggregation component 130. Thus, permutation array 134a does not have to be listed within the set 132 of permutation arrays in order to be considered when attempting to match aggregation component 130.

In yet another embodiment, aggregation component 140 is associated with a second set of permutation arrays. In this case, each allowable ordering of aggregation component 140, as established by the second set of permutation arrays, is compared to each allowable ordering of aggregation component 130, as established by the first set 132 of permutation arrays 134a-134d.

The second object may also be matched with a cataloged first object based on an imperfect or incomplete matching of attributes. For example, if aggregation component 140 were to include a SCSI adapter card in place of the networking card, the second object would only match three of the four attributes associated with the first object. Server 100 would then produce a match score of 75% when comparing the first object to the second object. Alternatively, a decreased match score may also be obtained where all four attributes are present in the second object, but in an ordering that differs from the ordering designated by set 132.

The amount of the decrease in the match score caused by an imperfect matching of attributes can be weighted in numerous ways, depending on the priorities placed on the desired match. For example, greater emphasis may be placed on exact matching of attributes, in which case an ordering difference may result in a nominally reduced match score. In other situations, however, greater emphasis is placed on the ordering, so that any deviation from the orderings listed in the set of permutation arrays would result in a large decrease in match score. These weightings may be predetermined on server 100 or may be decided by the user as part of the cataloging process.

Various methods can be used to produce more accurate matches between objects. For example, server 100 may disregard minor misspellings or typographical errors in comparing the attributes listed in the first and second aggregation components 130, 140. Alternatively, the users may be provided with a menu of possible attributes from which to select the attributes contained within the aggregation components, thereby incorporating elements from conventional hierarchical-type searching. An increased matching accuracy and uniformity can therefore be obtained by limiting the users to a certain predetermined list of attributes to associate with the objects to be cataloged. This technique would also reduce the incidence of users miscategorizing the objects they are searching.

In another aspect of the present invention, permutation array classes can be provided as a shorthand notation indicating certain predetermined orderings. For example, a class indicator of “*” may be assigned to a permutation array to indicate that a reverse ordering is permissible. Therefore, the reverse class indicator in the following permutation array:

(1, 2, 3, 4)*

is the equivalent of a set of permutation arrays consisting of:

(1, 2, 3, 4)

(4, 3, 2, 1)

Thus, when server 100 attempts to match a second object with the first object associated with a permutation array having the reverse class indicator, the ordering of the attributes associated with the second object is compared to each of the two permutation arrays listed above.

Other classes are also possible. For example, the rotation class indicator of “-” assigned to the following permutation array:

(1, 2, 3, 4)-

is the equivalent of the set of permutation arrays:

(1, 2, 3, 4)

(2, 3, 4, 1)

(3, 4, 1, 2)

(4, 1, 2, 3)

Accordingly, the comparison of the ordering of attributes from the second object is performed for each of the four permutation arrays above.

FIG. 4 illustrates a set 142 including permutation arrays 144a-144b, each of which is assigned a reverse class indicator. By using the reverse class indicator in conjunction with smaller permutation arrays 144a-144b, set 142 becomes the effective equivalent of set 132. Therefore, the comparison of aggregation component 140 to aggregation component 130 results in a match.

It will be understood that the objects to be cataloged may consist of a hierarchy of objects and sub-objects, each associated with an aggregation component linked with a set of permutation arrays. Thus, the cataloging method described above with respect to the single motherboard object having one level of attributes may also be applied to a large hierarchical tree of objects and sub-objects, such as an entire computer system having a motherboard as one of its components.

Although the invention has been described with reference to particular embodiments, the description is only an example of the invention's application and should not be taken as a limitation. In particular, even though much of the preceding discussion is aimed at cataloging a request for computer components, embodiments of the invention include cataloging descriptions, properties of items, functions of tools, or any type of information for which storage and retrieval is useful. In addition, there need not be a second user in order to generate the second object to be matched with the first object. It is also possible to have a single user cataloging numerous pieces of information, and later issuing queries to search for that information. Various other adaptations and combinations of features of the embodiments disclosed are within the scope of the as defined by the following claims.

I claim:

1. A method of cataloging objects on a computer system, comprising:
associating a first object with a first plurality of attributes using a first aggregation component; and
linking the first aggregation component with a first set of permutation arrays, each of said permutation arrays indicating an ordering of the first plurality of attributes.

2. The method of claim 1, further comprising:
assigning a class for one of the permutation arrays in the first set of permutation arrays, wherein said class indicates an alternative ordering for the permutation array for which said class is assigned.

3. The method of claim 2, wherein said class indicates a reverse ordering for the permutation array for which said class is assigned.

4. The method of claim 2, wherein said class indicates a rotated ordering for the permutation array for which said class is assigned.

5. The method of claim 1, further comprising:
associating a second object with a second plurality of attributes using a second aggregation component; and
matching the first object with the second object by comparing the ordering of the second plurality of attributes with the ordering of the first plurality of attributes for each of the permutation arrays in the first set of permutation arrays.

6. The method of claim 5, further comprising:
linking the second aggregation component with a second set of permutation arrays comprising one or more permutation arrays, each permutation array indicating an ordering of the second plurality of attributes;
wherein said matching comprises comparing the ordering of the first plurality of attributes for each of the permutation arrays in the first set of permutation arrays with the ordering of the second plurality of attributes for each of the permutation arrays in the second set of permutation arrays.

7. The method of claim 6, further comprising:
associating each attribute in the first plurality of attributes with an instance;
associating each attribute in the second plurality of attributes with an instance;
wherein the first set of permutation arrays indicate an ordering of the instances associated with each attribute in the first plurality of attributes and the second set of permutation arrays indicate an ordering of the instances associated with each attribute in the second plurality of attributes; and
said matching the first object with the second object comprises comparing the ordering of the instances associated with each attribute in the second set of attributes for each of the permutation arrays in the second set of permutation arrays with the ordering of the instances associated with each attribute in the first plurality of attributes for each of the permutation arrays in the first set of permutation arrays.

8. The method of claim 5, further comprising:
determining a match score based on the number of matching attributes in the first and second plurality of attributes.

9. The method of claim 8, wherein the match score is decreased based on a number of non-matching attributes between the first and second plurality of attributes.

10. A computer system for cataloging objects, the system comprising:
a computer; and
a computer program executable by the computer, wherein the computer program includes computer instructions for:
associating a first object with a first plurality of attributes using a first aggregation component; and
linking the first aggregation component with a first set of permutation arrays, each of said permutation arrays indicating an ordering of the first plurality of attributes.

11. The computer system of claim 10, wherein the computer program further comprises computer instructions for:
assigning a class for one of the permutation arrays in the first set of permutation arrays, wherein said class indicates an alternative ordering for the permutation array for which said class is assigned.

12. The computer system of claim 11, wherein said class indicates a reverse ordering for the permutation array for which said class is assigned.

13. The computer system of claim 11, wherein said class indicates a rotated ordering for the permutation array for which said class is assigned.

14. The computer system of claim 10, wherein the computer program further comprises computer instructions for:
associating a second object with a second plurality of attributes using a second aggregation component; and
matching the first object with the second object by comparing the ordering of the second plurality of attributes with the ordering of the first plurality of attributes for each of the permutation arrays in the first set of permutation arrays.

15. The computer system of claim 14, wherein the computer program further comprises computer instructions for:
linking the second aggregation component with a second set of permutation arrays comprising one or more permutation arrays, each permutation array indicating an ordering of the second plurality of attributes;
wherein said matching comprises comparing the ordering of the first plurality of attributes for each of the permutation arrays in the first set of permutation arrays with the ordering of the second plurality of attributes for each of the permutation arrays in the second set of permutation arrays.

16. The computer system of claim 15, wherein the computer program further comprises computer instructions for:
associating each attribute in the first plurality of attributes with an instance;
associating each attribute in the second plurality of attributes with an instance;
wherein the first set of permutation arrays indicate an ordering of the instances associated with each attribute in the first plurality of attributes and the second set of permutation arrays indicate an ordering of the instances associated with each attribute in the second plurality of attributes; and
said matching the first object with the second object comprises comparing the ordering of the instances associated with each attribute in the second set of attributes for each of the permutation arrays in the second set of permutation arrays with the ordering of the instances associated with each attribute in the first plurality of attributes for each of the permutation arrays in the first set of permutation arrays.

17. The computer system of claim 14, wherein the computer program further comprises computer instructions for:
determining a match score based on the number of matching attributes in the first and second plurality of attributes.

18. The computer system of claim 17, wherein the match score is decreased based on a number of non-matching attributes between the first and second plurality of attributes.
